(19) United States
(12) Patent Application Publication
(10) Pub. No.: US 2007/0283048 A1
(43) Pub. Date: Dec. 6, 2007

(54) Method, Apparatus and Computer Program Product for Providing Universal Information Transcoding

(75) Inventors: Wolfgang Theimer, Bochum (DE); Andree Ross, Lunen (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/421,558

(22) Filed: Jun. 1, 2006

(51) Int. Cl. G06F 15/16

(52) U.S. Cl. 709/246

(57) ABSTRACT

An apparatus comprising a conversion application includes a capability determining element and a local transcode server. The capability determining element is configured to determine a first format of source data, determine an information format for converted data, and determine local conversion capabilities. The local transcode server is configured to convert the source data in the first format to the converted data in a second format using local resources in response to the local conversion capabilities indicating that conversion from the first format to the second format is capable of performance using local resources. If conversion cannot be performed using local resources, then remote resources are located and utilized for the conversion.

### TECHNOLOGICAL FIELD

Embodiments of the present invention relate generally to mobile electronic device technology and, more particularly, relate to methods, apparatuses, and a computer program product for providing universal information transcoding using a mobile electronic device.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One impediment to increasing ease of information transfer relates to the fact that there are numerous data processing and communication platforms that operate with incompatible formats. Today, nearly all data and information are being digitized. As digitization of nearly all information progresses, the number of processing platforms and diversity of formats of multimedia and documents produced by the processing platforms increases. Accordingly, it is often common that certain devices are incompatible with a format of multimedia or documents produced by another device. Such incompatibility is often frustrating to users who wish to experience a seamless interworking of data between different devices.

In order to address the problem described above, several devices have been developed in an effort to translate information such as multimedia or documents between different devices. Such devices may be embodied as transcoding programs for computer systems, which are capable of converting from one file format or codec to another format or codec. The transcoding programs may act as file conversion tools, which may be available as freeware or shareware. Additionally, plug-ins may be available to permit the import or export of certain desirable functionalities. Online services, such as web based services, have been made available to upload a particular file in one format and download a converted version in a second format. However, the above described solutions are often tailored to a conversion between a limited number of selected formats. Furthermore, the user may be required to search out an appropriate conversion tool or constantly maintain and update a conversion tool, which could require significant effort since new formats are developed quite regularly.

Thus, users would benefit from a conversion tool that could minimize user effort, but provide a very robust and virtually limitless conversion capability. In light of the shortcomings described above, there may be a need to develop a device capable of providing universal information transcoding.

### BRIEF SUMMARY

A method, apparatus and computer program product are therefore provided that provide universal information transcoding. In particular, an apparatus is provided that is capable of providing universal transcoding using a portable device. As such, the apparatus provides a mobile gateway or router capable of performing any file format conversion. The mobile gateway may be a mobile terminal such as a mobile telephone, PDA, pager, gaming device, etc. As such, the mobile gateway may include a robust conversion capability by implementing, for example, a transcoding server as part of a conversion application disposed at the mobile gateway. The mobile gateway may also include the capability of accessing a comprehensive remote transcoding server accessible, for example, via the internet or over the air. Accordingly, in some situations, the mobile gateway will provide conversion using resources disposed at the mobile gateway, while in other situations, when the mobile gateway determines the resources for providing a particular conversion are not available at the mobile gateway, the mobile gateway will access the remote transcoding server.

In one exemplary embodiment, a method of providing universal information transcoding is provided. The method includes determining a first format of source data, determining an information format for converted data, determining local conversion capabilities, and converting the source data in the first format to the converted data in a second format using local resources in response to the local conversion capabilities indicating that conversion from the first format to the second format is capable of performance using local resources.

In another exemplary embodiment, a computer program product for providing universal information transcoding is provided. The computer program product includes at least one computer-readable storage medium having computer-readable program code portions stored therein. The computer-readable program code portions include first, second, third and fourth executable portions. The first executable portion is for determining a first format of source data. The second executable portion is for determining an information format for converted data. The third executable portion is for determining local conversion capabilities. The fourth executable portion is for converting the source data in the first format to the converted data in a second format using local resources in response to the local conversion capabilities indicating that conversion from the first format to the second format is capable of performance using local resources.

In another exemplary embodiment, an apparatus for providing universal information transcoding is provided. The apparatus includes a capability determining element and a local transcode server. The capability determining element is configured to determine a first format of source data, determine an information format for converted data, and determine local conversion capabilities. The local transcode server is configured to convert the source data in the first format to the converted data in a second format using local resources in response to the local conversion capabilities indicating that conversion from the first format to the second format is capable of performance using local resources.

In another exemplary embodiment, a system for providing universal information transcoding is provided. The system includes a mobile gateway and a remote transcode server. The mobile gateway includes a capability determining element and a local transcode server. The capability determining element is configured to determine a first format of source data, determine capabilities of an output device with respect to information formats for converted data, and determine local conversion capabilities of the local transcode server. The local transcode server is configured to convert the source data in the first format to the converted data in a second format in response to the local conversion capabilities indicating that conversion from the first format to the second format is capable of performance using the local transcode server. The remote transcode server is in communication with the mobile gateway. The mobile gateway is configured to convert the source data in the first format to the converted data in the second format using the remote transcode server in response to the local conversion capabilities indicating that conversion from the first format to the second format is not capable of performance using the local transcode server.

In another exemplary embodiment, an apparatus for providing universal information transcoding is provided. The apparatus includes means for determining a first format of source data, means for determining an information format for converted data, means for determining local conversion capabilities, and means for converting the source data in the first format to the converted data in a second format using local resources in response to the local conversion capabilities indicating that conversion from the first format to the second format is capable of performance using local resources.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of portions of a system for providing universal information transcoding according to an exemplary embodiment of the present invention;

FIG. 4 illustrates a block diagram of portions of a system for providing universal information transcoding according to an exemplary embodiment of the present invention; and

FIG. 5 is a block diagram according to an exemplary method for providing universal information transcoding according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

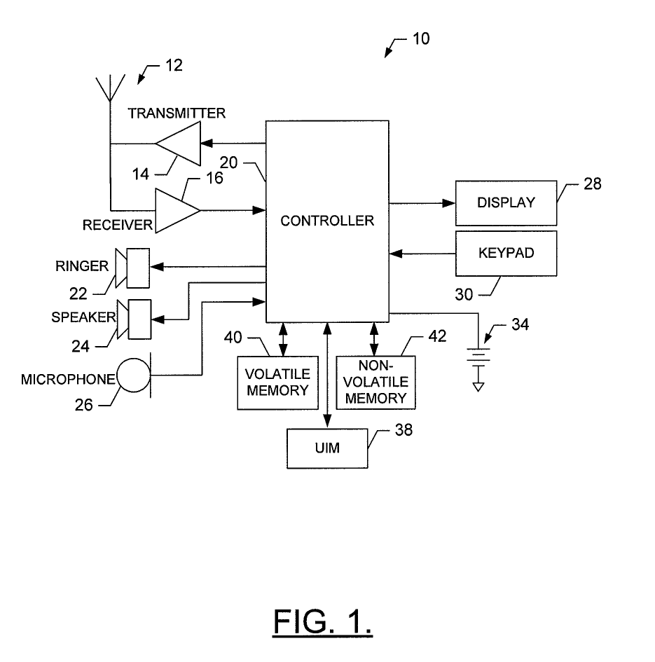

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, laptop computers, gaming devices and other types of voice and text communications systems, can readily employ embodiments of the present invention.

In addition, while several embodiments of the method of the present invention are performed or used by a mobile terminal 10, the method may be employed by other than a mobile terminal. Moreover, the system and method of exemplary embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

The mobile terminal 10 includes an antenna 12 in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, and TD-SCDMA.

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser or a Web server. The connectivity program may then allow the mobile terminal 10 to transmit and receive Web content, such as location-based content, according to a Wireless Application Protocol (WAP), for example. Also, for example, the controller 20 may be capable of operating a software application capable of analyzing text and selecting music appropriate to the text. The music may be stored on the mobile terminal 10 or accessed as Web content.

The mobile terminal 10 also comprises a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (b 0-9) and related keys (#, *), and other keys used for operating the mobile terminal 10. Alternatively, the keypad 30 may include a conventional QWERTY keypad arrangement. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a universal identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

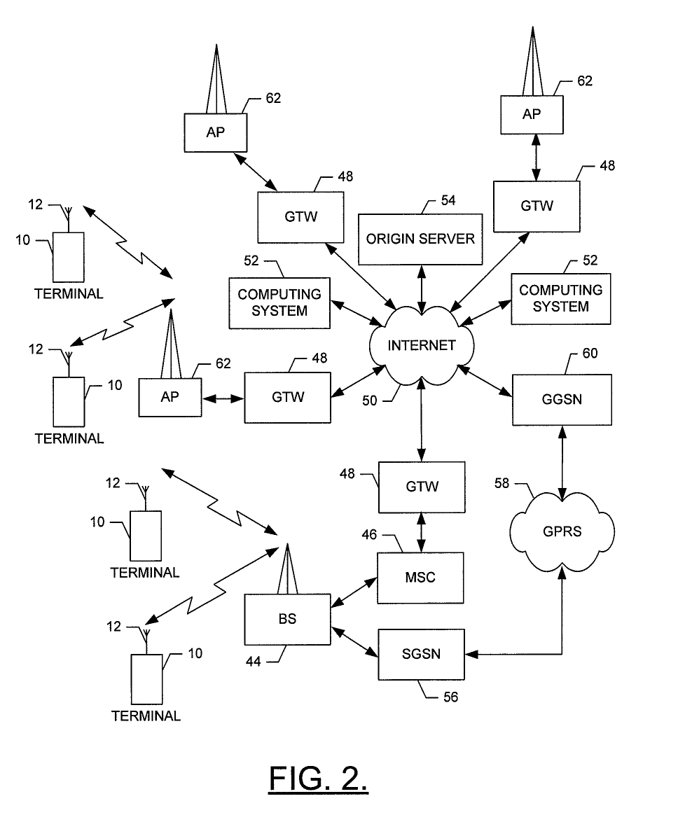

Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

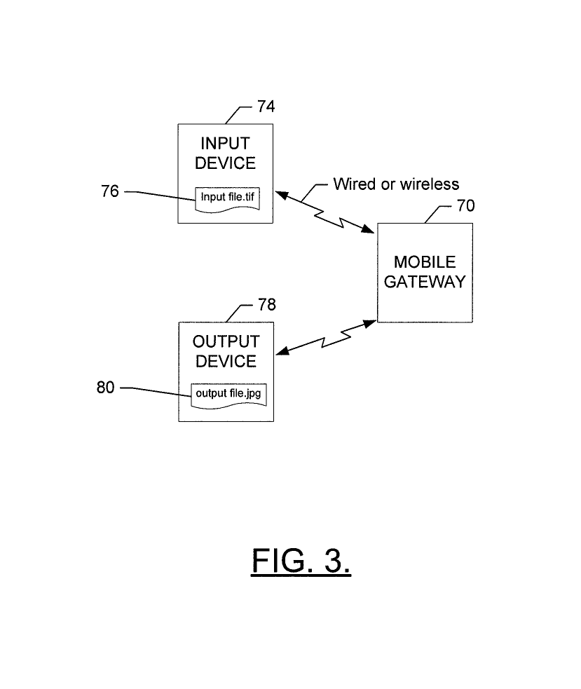

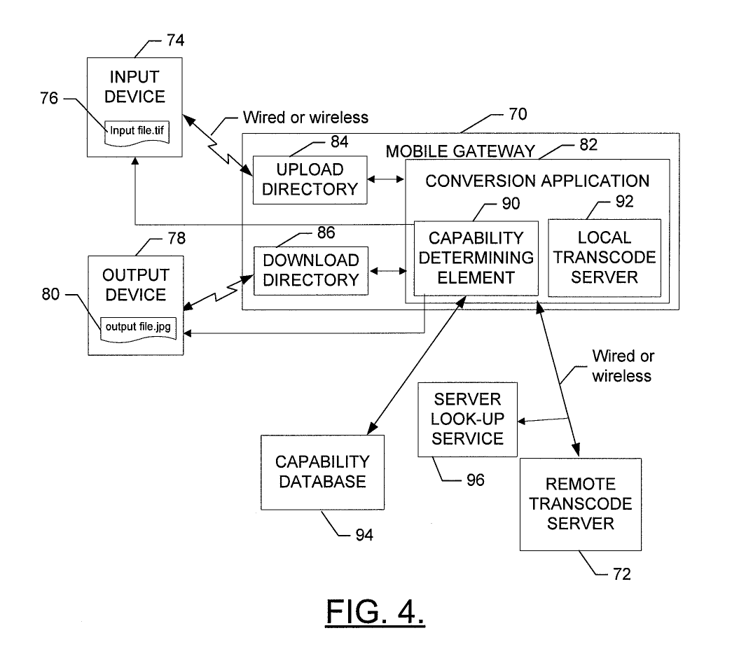

An exemplary embodiment of the invention will now be described with reference to FIGS. 3 and 4, in which certain elements of a system for providing universal information transcoding are displayed. A mobile gateway and router of FIGS. 3 and 4 may be, for example, the mobile terminal 10 of FIG. 1. However, it should be noted that the systems of FIGS. 3 and 4, may also be employed in conjunction with a variety of other devices, both mobile and fixed, and therefore, the embodiments of the present invention should not be limited to application with devices such as the mobile terminal 10 of FIG. 1. Alternatively, the mobile gateway and router may be an element or module of the mobile terminal 10 of FIG. 1 or any other mobile or fixed device. It should also be noted, however, that while FIGS. 3 and 4 illustrate examples of a configuration of a system for providing efficient evaluation in feature transformation, numerous other configurations may also be used to implement embodiments of the present invention.

Referring now to FIG. 3, a system for providing universal information transcoding is illustrated. The system includes a mobile gateway 70 and may also include an input device 74 capable of providing an input file 76 to be converted at the mobile gateway 70 and an output device 78 capable of receiving an output file 80 which is converted from the mobile gateway 70. As such, the input device 74 is an information source, while the output device 78 is an information drain. It should be noted that although FIG. 3 illustrates the mobile gateway 70 as being a separate element from the input device 74 and the output device 78, the mobile gateway 70 may also act as either an input or an output device. In other words, the mobile gateway 70 may itself form, create or otherwise originate the input file 76 to be converted for output of the output file 80 to the output device 78 thereby acting as an information source. Alternatively, the mobile gateway 70 may receive the input file 76 to be converted from the input device 74 and, following conversion of a file format of the input file 76, the mobile gateway 70 may act as an output device to output, for example audio, video, text or other content responsive to conversion of the input file 76. As such, the mobile gateway 70 may act as an information drain. In any case, regardless of an identity of the input and output devices, it should be understood that the mobile gateway 70 of an exemplary embodiment converts a file format of the input file 76 into a format that is compatible or otherwise understandable and usable at the output device 78. As such, although the following will be described in terms of converting between formats of the input file 76 and the output file 80, the input file 76 need not actually be input into the mobile gateway 70 and thus could be considered instead to be source data. Likewise, the output file 80 need not actually be output to the output device 78 and thus the output file 80 may be considered instead to be converted data. In other words, either the input device 74 or the output device 78 could form a portion of the same device in which the mobile gateway 70 is embodied.

The input device 74 and the output device 78 may be any information source or drain. Some examples of typical input devices and output devices include computers, hard drives, mobile phones, music players, home stereo systems, etc. However, embodiments of the present invention are not limited to use with the devices listed above. As such, the devices listed above are provided for purposes of example and not of limitation.

In order to perform such conversion, the mobile gateway 70 includes a conversion application 82 as shown in FIG. 4. Referring now to FIG. 4, another system for providing universal information transcoding is provided which describes an embodiment of the mobile gateway 70 in greater detail. The system of FIG. 4 includes the mobile gateway 70 and may also include a network device such as a remote transcode server 72 in communication with the conversion application 82 of the mobile gateway 70. The remote transcode server 72 may be in communication with the conversion application 82 and thus with the mobile gateway 70, for example, via either an over-the-air (i.e., wireless) connection or a wired connection. In an exemplary embodiment, the remote transcode server 72 may be in communication with the mobile gateway 70 via the internet. The remote transcode server 72 may be any means or device embodied in either hardware, software, or a combination of hardware and software capable of providing format conversions between any of a plurality of formats including proprietary formats and other commonly used formats. In an exemplary embodiment, the remote transcode server 72 may be capable of providing conversion between any known format and any other known format. As such, the remote transcode server 72 may include a single robustly capable server having continuously updated conversion data to maintain the capability to convert between any known format and any other known format. Alternatively, the remote transcode server 72 may include a plurality of transcode servers. In such a case, or alternatively, the conversion application 82 may be in communication with a server look-up service 96 which is capable of, for example, searching the internet or a plurality of transcode servers in order to locate respective conversion data to enable the conversion application 82 to provide conversion between any known format and any other known format.

In an exemplary embodiment, the mobile gateway 70 may implement web based technologies. For example, the mobile gateway 70 may be operated via a browser disposed, for example, at the mobile gateway 70 or at a device in communication with the mobile gateway 70. In other words, in a situation where the mobile gateway 70 is embodied as the mobile terminal 10, the browser may be a browser of the mobile terminal 10. Alternatively, a browser, for example, of a remote user interface device such as a personal computer may be in communication with the mobile gateway 70. In either example above, the browser may enable a user to assign a desired destination format for information received. As such the user may assign a particular destination format based on the user's knowledge of a particular output device or the user's desires. Alternatively, the user may select a destination format from a list of formats supported by a particular output device in communication with the mobile gateway 70. In such a case, the mobile gateway 70 may automatically query the output device to determine which formats the output device supports and display the supported formats to the user to enable user selection of one of the formats supported as the destination format. Alternatively, the mobile gateway 70 may determine capabilities of the output device 78 and automatically assign the desired destination format from among those formats the output device 78 is capable of using. Such an automatic assignment may be made based upon a preference of the mobile gateway 70 to perform conversions between particular formats which may be common or supportable using a minimum of resources.

In an exemplary embodiment, the conversion application 82 may act as a mobile web server which is accessible via the browser, for example, of the mobile terminal 10. The conversion application 82 may be any device or means embodied in either hardware, software, or a combination of hardware and software capable of providing or arranging for conversion between any two file formats. In an exemplary embodiment, the conversion application 82 may be embodied in software as instructions that are stored on a memory (such as a memory of the mobile terminal 10) and executed by a processing element (such as the controller 20). Alternatively, the mobile gateway 70 may itself include a memory device and a processing element. A processing element such as those described above may be embodied in many ways. For example, the processing element may be embodied as a processor, a coprocessor, a controller or various other processing means or devices including integrated circuits such as, for example, an ASIC (application specific integrated circuit).

In an exemplary embodiment, the mobile gateway 70 may include an upload directory 84 and a download directory 86. The upload and download directories 84 and 86 are each in electrical communication with the conversion application 82. The upload and download directories 84 and 86 may each be any means or device capable of storing information such as a file, regardless of a format of the file. As such, the upload and download directories 84 and 86 may each be embodied, for example, as a memory device, register or buffer capable of storing information. The upload directory 84 may be configured to receive the input file 76 to be converted prior to communication of the input file 76 to the conversion application 82. Meanwhile, the download directory 86 may be configured to receive the output file 80, which has been converted, from the conversion application 82. In an exemplary embodiment, communication between the upload and download directories 84 and 86 and the input and output devices 74 and 78, respectively, may be in communication with each other via either a wired or wireless connection using internet protocol (IP) or any other suitable protocol for communication.

The conversion application 82 may include a capability determining element 90 and a local transcode server 92. The capability determining element 90 may be any device or means embodied in either hardware, software, or a combination of hardware and software capable of determining capabilities of devices in communication with the mobile gateway 70, or of the mobile gateway 70 itself. In an exemplary embodiment, the capability determining element 90 may be embodied as instructions stored on a memory device and executed by a processing element. Accordingly, the capability determining element 90 may be configured to determine the capabilities of a particular device to provide or receive information in a particular format. Furthermore, the capability determining element 90 may be configured to determine whether, given a particular format of the input file 76, the local transcode server 92 is capable of converting the input file 76 into a desired format of the output file 80 or if the conversion application 82 should engage the remote transcode server 72 to perform the conversion. The capability determining element 90 may access a capability database 94 in order to determine corresponding capabilities of devices in communication with the mobile gateway 70. In an exemplary embodiment, the capability determining element 90 may communicate with the input and/or output devices 74 and 78 to access the capability database 94, which may be disposed on the input and/or output devices 74 and 78, respectively, which thereby communicates the corresponding capabilities of the input and/or output devices 74 and 78 to the conversion application 82. In another exemplary embodiment, the capability determining element 90 may access the capability database 94 on the mobile gateway 70. In yet another exemplary embodiment, the capability database 94 may be disposed on a network device and accessed by the conversion application 82, for example, via the internet or a wireless connection. Although the preceding description is directed to determining capabilities using a capability database, any other suitable method is also envisioned.

The local transcode server 92 may be any means or device embodied in either hardware, software, or a combination of hardware and software that is capable of providing file format conversions between any of a plurality of formats including proprietary formats and other commonly or uncommonly used formats. In an exemplary embodiment, the local transcode server 92 may include a capability to convert between a number of the most common file formats and codecs. In other words, the local transcode server 92 may be configured to support a number of the most common conversions. If desired, the local transcode server 92 may be a small server capable of supporting a limited number of conversions. Such a small server may be advantageous in certain embodiments of the present invention in which size of the mobile gateway 70 (or size of the mobile terminal 10) is desirably minimized.

It should be noted that although the capability determining element 90 may enable the mobile gateway 70 to determine the capabilities of both the input and output devices 74 and 78, it may not be desirable to determine the capabilities of the input device 74. Instead, only the format of the input file 76 may be determined. As such, processing at the mobile gateway 70 may be minimized since the input file 76 may be taken “as is” and conversion to a desirable format of the output file 80 may be undertaken by the conversion application 82 with minimal processing. Thus, the capability determining element 90 may determine a first format of the input file 76 and then determine the capabilities of the output device 78 and select a second format (or the user may select the second format) with which the output device 78 is compatible. The capability determining element 90 may then determine the capabilities of the mobile gateway 70 to determine if conversion from the first format to the second format is supported by the local transcode server 92 or if conversion must be performed by the remote transcode server 72. It should be noted that, in situations where the output device is compatible with multiple formats, the second format may be selected based on the capabilities of the mobile gateway 70. In other words, the capability determining element 90 may determine that a conversion between the first and second formats is supported by the local transcode server 92, while a conversion into other formats supported by the output device 78 would not be supported by the local transcode server 92. As such, the capability determining element 90 may instruct the conversion application 82 to convert from the first format to the second format in order to maximize conversion efficiency by performing the conversion at the mobile gateway 70 instead of utilizing resources external to the mobile gateway 70 (i.e. the remote transcode server 72).

In exemplary embodiments in which the capabilities of the input device 74 are determined, such determination may be useful in situations in which the input device 74 is capable of providing the input file 76 in numerous alternative formats. As such, the capability determining element 90 may determine the capabilities of the input device 74 in order to determine, based on the conversions supported by the local transcode server 92, which format in which to request the input file 76 to be communicated to the mobile gateway 70. Thus, where conversion from a first format to a second format is supported by the local transcode server 92, the capability determining element may communicate with the input device 74 to request the input file 76 in the first format (from among a number of formats supported by the input device 74) in order to enable conversion from the first format of the input file 76 into the second format at the output file 80.

In operation, according to an exemplary embodiment, the input file 76 is received at the upload directory 84. The conversion application 82 may then access the input file 76 from the upload directory 84 to determine a file format of the input file 76 (for example, the first format). Alternatively, as described above, the upload directory may receive the input file 76 in the first format responsive to a request from the mobile gateway 70 to receive the input file 76 in the first format after the capability determining element 90 has determined the capabilities of the input device 74. Thereafter, based on the determination of the capabilities of the output device 78 a second format is selected (automatically or by the user) for the output file 80 and the capability determining element 90 determines whether the local transcode server 92 is capable of performing the conversion from the first format to the second format. If the local transcode server 92 is capable of performing the conversion from the first format to the second format, then the conversion application 82 employs the local transcode server 92 to perform the conversion. If the local transcode server 92 is not capable of performing the conversion from the first format to the second format, then the conversion application 82 communicates with the remote transcode server 72 to effectuate conversion from the first format to the second format. As stated above, the server look-up service 96 may be employed to locate remote resources for performing the conversion.

If necessary or desired, a third format or other intermediate formats may be employed at either or both of the local or remote transcode servers 92 or 72 in order to effectuate the conversion from the first format to the second format. Following conversion from the first format to the second format, the output file 80, which is in the second format, may be stored in the download directory 86 which is in communication with both the local and remote transcode servers 92 and 72. From the download directory 86, the output file 80 may either be pushed to the output device 78 or pulled from the download directory 86 by the output device 78.

It should be noted that the operations described above may be conducted during a real time conversion or may be conducted asynchronously. As an example of a real time conversion, the mobile gateway 70 may be placed in communication with the input and output devices 74 and 78 via either a wireless connection, a wired connection such as, for example, via universal serial bus (USB) connection using a mass storage profile and the input file 76 may be uploaded to the upload directory 84. Alternatively, file server functionality may be implemented on the input device 74 and the browser described above may be employed to browse various files on the input device 74 to select a particular file as the input file 76, which is then uploaded to the upload directory 84. After upload at the upload directory, the conversion application 82 may be employed to perform conversion using either of the local or remote transcode servers 92 and 72 as described above. The output file 80 may then be stored momentarily at the download directory 86 before the output file 80 is either pushed to the output device 78 or pulled from the download directory 86 by the output device 78. In the above described example, it is assumed that the only delays between input of the input file 76 and output of the output file 80 are due to processing times within the mobile gateway 70 or, if necessary, at the remote transcode server 72. In other words, neither the input file 76 nor the output file 80 is necessarily stored in the mobile gateway 70 beyond the time necessary to perform the conversion and output the output file 80. As such, the upload and download directories 84 and 86 may only be temporary storage devices and the input 76 and output files 80 may be deleted automatically following completion of each conversion process.

A real world example of such an operation may be realized in a situation in which a user wishes to access a music file which is stored in a first format on a mass storage device and play content associated with the music file on the user's home stereo in a second format. As such, the mobile gateway 70 may be placed in electronic communication with both the mass storage device (i.e., the input device 74) and the home stereo (i.e., the output device 78), for example, via USB connection. A browser application on the mobile gateway 70 may be used to access the music file from the mass storage device for immediate conversion to the second format for output at the home stereo.

An example of asynchronous conversion may be any of the following. In one exemplary embodiment, the user may be at a friend's house and wish to receive a copy of a particular music file from the friend's mass storage device in order to enable the user to play the particular music file at the user's home stereo. Accordingly, the user may upload the particular music file into the upload directory 84 for storage, for example, via USB connection. When the user arrives at the user's house, the user may place the mobile gateway 70 in communication with the user's home stereo, for example, via USB connection. Following a determination of the capabilities of the user's home stereo, the second format may be selected and conversion may be performed from the first format to the second format, as described above, using either of the local or remote transcode servers 92 or 72 to produce the output file 80 to be stored in the download directory 86. The output file 80 may then either be pushed from the download directory 86 to the home stereo or the home stereo may pull the output file 80 from the download directory 86. Following output of the output file 80 to the home stereo, copies of the input file 74 and/or the output file 80 may be expunged from the upload and/or download directories 84 and 86, respectively, or stored in either or both of the upload and/or download directories 84 and 86 indefinitely.

In another exemplary embodiment, the process described above is substantially the same except that if the user knows the second format which the home stereo employs, the user may select conversion from the first format to the second format at the time of upload of the input file 76 and the output file 80, which is in the second format 80, may be stored at the download directory 86 indefinitely to enable the user to output the output file 80 to the home stereo at a future time selected by the user. In other words, according to either of the exemplary embodiments above describing asynchronous conversion, the upload and/or download directories 84 and 86 may be used as long term storage devices to store copies of information in the first and/or second formats for either conversion or output of the formats at some future time. Alternatively, the input file 74 and/or the output file 80 may be transferred internally or externally to a memory device for long term storage in either or both of the first and second formats.

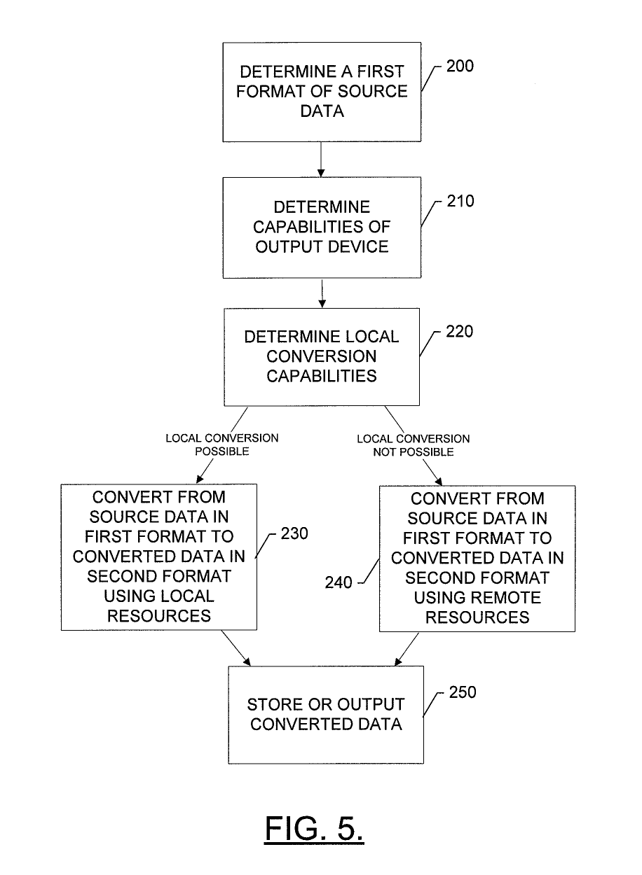

FIG. 5 is an example of flowcharts of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, FIG. 5 shows one embodiment of a method of providing universal information transcoding which includes determining a first format of source data at operation 200. At operation 210, capabilities of an output device are determined with respect to an information format for converted data. At operation 220, local conversion capabilities are determined. If the local conversion capabilities indicate that conversion from the first format to the second format may be performed using local resources, the source data is converted from the first format to the converted data in the second format using local resources at operation 230. The local resources may include a local transcode server. If the local conversion capabilities indicate that conversion from the first format to the second format may not be performed using local resources, the source data is converted from the first format to converted data in the second format using remote resources at operation 240. In an exemplary embodiment, as described above, a transcoding look-up server may be employed to locate resources remotely, such as via the internet, which are capable of performing the conversion from the first format to the second format. After conversion from the first format to the second format, the converted data may be stored or output at operation 250. In an exemplary embodiment, capabilities of an input device with respect to information format may also be determined. As such, the source data may be requested in the first format from the input device in response to the determination of local conversion capabilities.

The above described functions may be carried out in many ways. For example, any suitable means for carrying out each of the functions described above may be employed to carry out embodiments of the invention. In one embodiment, all or a portion of the elements of embodiments of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which embodiments of these inventions pertain having the benefit of the teachings presented in the foregoing descriptions and the associated drawings. Therefore, it is to be understood that embodiments of the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
determining a first format of source data;
determining an information format for converted data;
determining local conversion capabilities; and
converting the source data in the first format to the converted data in a second format using local resources in response to the local conversion capabilities indicating that conversion from the first format to the second format is capable of performance using local resources.

2. A method according to claim 1, further comprising converting the source data in the first format to the converted data in the second format using remote resources in response to the local conversion capabilities indicating that conversion from the first format to the second format is not capable of performance using local resources.

3. A method according to claim 2, further comprising locating the remote resources.

4. A method according to claim 2, wherein converting the source data in the first format to the converted data in the second format using remote resources comprises accessing the remote resources via a wide area network.

5. A method according to claim 1, further comprising storing the converted data.

6. A method according to claim 1, further comprising outputting the converted data to an output device.

7. A method according to claim 1, further comprising an initial operation of determining capabilities of an input device and an output device with respect to information formats.

8. A method according to claim 7, further comprising requesting the source data from the input device in the first format in response to the determination of the capabilities of the input device.

9. A method according to claim 7, wherein determining capabilities of the input and output devices is performed by accessing a database of capabilities.

10. A computer program product comprising at least one computer-readable storage medium having computer-readable program code portions stored therein, the computer-readable program code portions comprising:
a first executable portion for determining a first format of source data;
a second executable portion for determining an information format for converted data;
a third executable portion for determining local conversion capabilities; and
a fourth executable portion for converting the source data in the first format to the converted data in a second format using local resources in response to the local conversion capabilities indicating that conversion from the first format to the second format is capable of performance using local resources.

11. A computer program product according to claim 10, further comprising a fifth executable portion for converting the source data in the first format to the converted data in the second format using remote resources in response to the local conversion capabilities indicating that conversion from the first format to the second format is not capable of performance using local resources.

12. A computer program product according to claim 11, further comprising a sixth executable portion for locating the remote resources.

13. A computer program product according to claim 11, wherein the fifth executable portion includes instructions for converting the source data in the first format to the converted data in the second format using remote resources comprises accessing the remote resources via a wide area network.

14. A computer program product according to claim 10, further comprising a fifth executable portion for storing the converted data.

15. A computer program product according to claim 10, further comprising a fifth executable portion for outputting the converted data to an output device.

16. A computer program product according to claim 10, further comprising a fifth executable portion for an initial operation of determining capabilities of an input device and an output device with respect to information formats.

17. A computer program product according to claim 16, further comprising a sixth executable portion for requesting the source data from the input device in the first format in response to the determination of the capabilities of the input device.

18. A computer program product according to claim 16, wherein determining capabilities of the input and output devices is performed by accessing a database of capabilities.

19. An apparatus comprising a conversion application including:
a capability determining element configured to:
determine a first format of source data;
determine an information format for converted data; and
determine local conversion capabilities; and
a local transcode server configured to convert the source data in the first format to the converted data in a second format using local resources in response to the local conversion capabilities indicating that conversion from the first format to the second format is capable of performance using local resources.

20. An apparatus according to claim 19, wherein the conversion application is configured to convert the source data in the first format to the converted data in the second format using remote resources in response to the local conversion capabilities indicating that conversion from the first format to the second format is capable of performance using local resources.

21. An apparatus according to claim 20, wherein the conversion application is configured to communicate with a transcoding look-up server to locate the remote resources.

22. An apparatus according to claim 20, wherein the conversion application is configured to locate remote resources via a wide area network.

23. An apparatus according to claim 19, further comprising a download directory in communication with the conversion application for storing the converted data.

24. An apparatus according to claim 19, further comprising an upload directory in communication with the conversion application and an input device, and the capability determining element is configured to perform an initial operation of determining capabilities of the input device with respect to information formats.

25. An apparatus according to claim 24, wherein the conversion application is configured to request the source data from the input device in the first format in response to the determination of the capabilities of the input device.

26. An apparatus according to claim 24, wherein the conversion application is configured to access a database of capabilities in order to determine the capabilities of the input device and an output device.

27. An apparatus according to claim 19, further comprising a download directory in communication with the conversion application for receiving the converted data and an upload directory in communication with the conversion application and an input device to receive the source data from the input device, and both the upload and download directories are capable of storage of the input data and the converted data, respectively.

28. An apparatus according to claim 27, wherein the conversion application is configured to convert the source data to the converted data substantially in real time.

29. An apparatus according to claim 27, wherein the conversion application is configured to convert the source data to the converted data asynchronously.

30. An apparatus according to claim 27, wherein the apparatus is embodied in a mobile terminal.

31. An apparatus comprising:
a means for determining a first format of source data;
a means for determining an information format for converted data;
a means for determining local conversion capabilities; and
a means for converting the source data in the first format to the converted data in a second format using local resources in response to the local conversion capabilities indicating that conversion from the first format to the second format is capable of performance using local resources.

32. A system comprising:
a mobile gateway including a capability determining element and a local transcode server, the capability determining element being configured to determine a first format of source data, determine capabilities of an output device with respect to information formats for converted data, and determine local conversion capabilities of the local transcode server which is configured to convert the source data in the first format to the converted data in a second format in response to the local conversion capabilities indicating that conversion from the first format to the second format is capable of performance using the local transcode server; and
a remote transcode server in communication with the mobile gateway,
wherein the mobile gateway is configured to convert the source data in the first format to the converted data in the second format using the remote transcode server in response to the local conversion capabilities indicating that conversion from the first format to the second format is not capable of performance using the local transcode server.
